(19) United States
(12) Patent Application Publication
(10) Pub. No.: US 2006/0200346 A1
(43) Pub. Date: Sep. 7, 2006

(54) Speech quality measurement based on classification estimation

(75) Inventors: Wai-Yip Chan, Kingston (CA); Wei Zha, Sugar Land, TX (US); Mohamed El-Hennawey, Belleville (CA)

Correspondence Address: McGUINNESS & MANARAS LLP, 125 NAGOG PARK, ACTON, MA, 01720, US

(73) Assignee: Nortel Networks Ltd.

(21) Appl. No.: 11/364,251

(22) Filed: Feb. 28, 2006

Related U.S. Application Data
(60) Provisional application No. 60/658,330, filed on Mar. 3, 2005.

(51) Int. Cl. G10L 15/20

(52) U.S. Cl. 704/233

(57) ABSTRACT

Auditory processing is used in conjunction with cognitive mapping to produce an objective measurement of speech quality that approximates a subjective measurement such as MOS. In order to generate a data model for measuring speech quality from a clean speech signal and a degraded speech signal, the clean speech signal is subjected to auditory processing to produce a subband decomposition of the clean speech signal; the degraded speech signal is subjected to auditory processing to produce a subband decomposition of the degraded speech signal; and cognitive mapping is performed based on the clean speech signal, the subband decomposition of the clean speech signal, and the subband decomposition of the degraded speech signal. Various statistical analysis techniques, such as MARS and CART, may be employed, either alone or in combination, to perform data mining for cognitive mapping. From the large number of features extracted from the distortion surface, MARS is employed to find a smaller subset of features to form the speech quality estimator. The subset of feature variables, together with the particular manner of combining them, are jointly optimized to produce a statistically consistent estimate (data model) of subjective opinion scores such as MOS.

### CROSS-REFERENCE TO RELATED APPLICATIONS

A claim of priority is made to U.S. Provisional Patent Application 60/658,330, titled A METHOD OF SPEECH QUALITY MEASUREMENT BASED ON CLASSIFICATION-ESTIMATION, filed Mar. 3, 2005, which is incorporated by reference.

### FIELD OF THE INVENTION

This invention relates generally to the field of telecommunications, and more particularly to double-ended measurement of speech quality.

### BACKGROUND OF THE INVENTION

The capability of measuring speech quality in a telecommunications network is important to telecommunications service providers. Measurements of speech quality can be employed to assist with network maintenance and troubleshooting, and can also be used to evaluate new technologies, protocols and equipment. However, anticipating how people will perceive speech quality can be difficult. The traditional technique for measuring speech quality is a subjective listening test. In a subjective listening test a group of people manually, i.e., by listening, score the quality of speech according to, e.g., an Absolute Categorical Rating (“ACR”) scale, Bad (1), Poor (2), Fair (3), Good (4), Excellent (5). The average of the scores, known as a Mean Opinion Score (“MOS”), is then calculated and used to characterize the performance of speech codecs, transmission equipment, and networks. Other kinds of subjective tests and scoring schemes may also be used, e.g. degradation mean opinion scores (“DMOS”). Regardless of the scoring scheme, subjective listening tests are time consuming and costly.

It is also known to measure speech quality using automated, objective techniques. Early objective speech quality estimators calculated the difference between a clean speech waveform and a coded (degraded) speech waveform. Representative estimators include signal-to-noise ratio (“SNR”) and segmented SNR. However, low-bit-rate speech coders do not necessarily preserve the original waveform so waveform matching is not an ideal solution. More recently, speech quality measurement algorithms based on auditory models which do not require waveform mapping have been developed. Representative algorithms include Bark spectral distortion (“BSD”), measuring normalizing block (“MNB”), perceptual evaluation of speech quality (“PESQ”) and PSQM. One way in which the auditory model based techniques differ is in the processing of the auditory error surface. For example, MNB uses a hierarchical structure of integration over different time and frequency interval lengths. In contrast, PESQ uses a three step integration, first over frequency, then over short-time utterance intervals, and finally over the whole speech signal. Different p values are used in the Lp norm integration performed in the three steps. However, the integrations are ad hoc in nature and not based on cognitive insight. It would therefore be desirable to have a technique that would more accurately correlate with results that would be obtained via subjective listening tests.

### SUMMARY OF THE INVENTION

In accordance with one embodiment of the invention, a method for using a data model for measuring speech quality from a clean speech signal and a degraded speech signal, comprising the steps of: performing auditory processing of the clean speech signal, thereby producing a subband decomposition of the clean speech signal; performing auditory processing of the degraded speech signal, thereby producing a subband decomposition of the degraded speech signal; and performing cognitive mapping based on the clean speech signal, the subband decomposition of the clean speech signal, and the subband decomposition of the degraded speech signal.

In accordance with another embodiment of the invention, a computer program operable to use a data model for measuring speech quality from a clean speech signal and a degraded speech signal, comprising: logic operable to perform auditory processing of the clean speech signal, thereby producing a subband decomposition of the clean speech signal; logic operable to perform auditory processing of the degraded speech signal, thereby producing a subband decomposition of the degraded speech signal; and logic operable to perform cognitive mapping based on the clean speech signal, the subband decomposition of the clean speech signal, and the subband decomposition of the degraded speech signal.

Employing data mining to identify characteristics of speech signals that correlate to speech quality has advantages over known techniques. For example, data mining facilitates design of more easily scalable quality estimators. This could be significant because it is generally desired in the telecommunications field to have an estimator that can scale with the amount of data available for learning cognitive mapping, which is increasing because new forms of speech degradation arise from newly collected learning samples, new transmission environments, new speech codecs, and other technological changes.

The inventive technique also has the advantage of simplicity of implementation. For example, features selected using data mining enable the auditory processing model to be simplified since the auditory processing model need only produce the selected features.

### BRIEF DESCRIPTION OF THE FIGURES

FIG. 1 is a block diagram of speech quality measurement based on classification-estimation.

FIG. 2 is a block diagram of the processing steps in an auditory processing module of FIG. 1.

FIG. 3 is a block diagram of cognitive mapping.

FIG. 4 illustrates the selected subset of features and the data model for computing objective MOS.

### DETAILED DESCRIPTION

Human speech quality judgment process can be divided into two parts. The first part, auditory processing, is the conversion of the received speech signal into auditory nerve excitations for the brain. Techniques for objectively measuring auditory processing are well documented as auditory periphery system models. The second part is cognitive processing in the brain. In cognitive processing, compact features related to anomalies in the speech signal are extracted and integrated to produce a final speech quality. In accordance with the illustrated embodiments of the invention, this second part is objectively measured based on statistical data mining of data from human subjects, i.e., cognitive mapping.

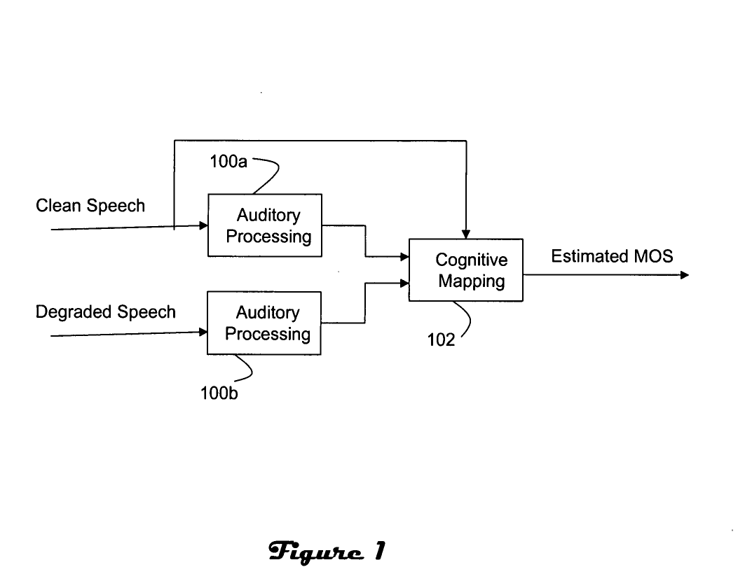

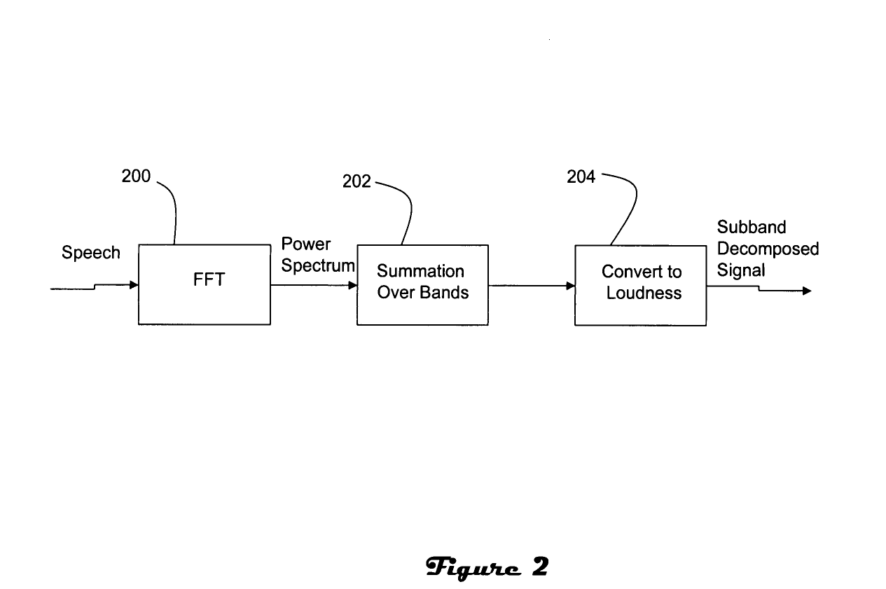

Referring to FIGS. 1 and 2, human auditory processing is approximated, as shown in steps (100a, 100b) by the illustrated steps (200-204). Initially, the speech signal is divided into overlapping frames. The spectral power density of each frame is then obtained via FFT (200). Hertz-to-Bark frequency transformation is performed by summing an appropriate set of power density coefficients as shown in step (202). The summed powers are then converted to subjective loudness using Zwicher's Law as shown in step (204). The final frequency decomposed signal for each speech frame is in sone/Bark unit. In the illustrated embodiment the signal is decomposed into 7 subbands, with each subband approximately 2.5 Bark wide for telephone bandwidth speech.

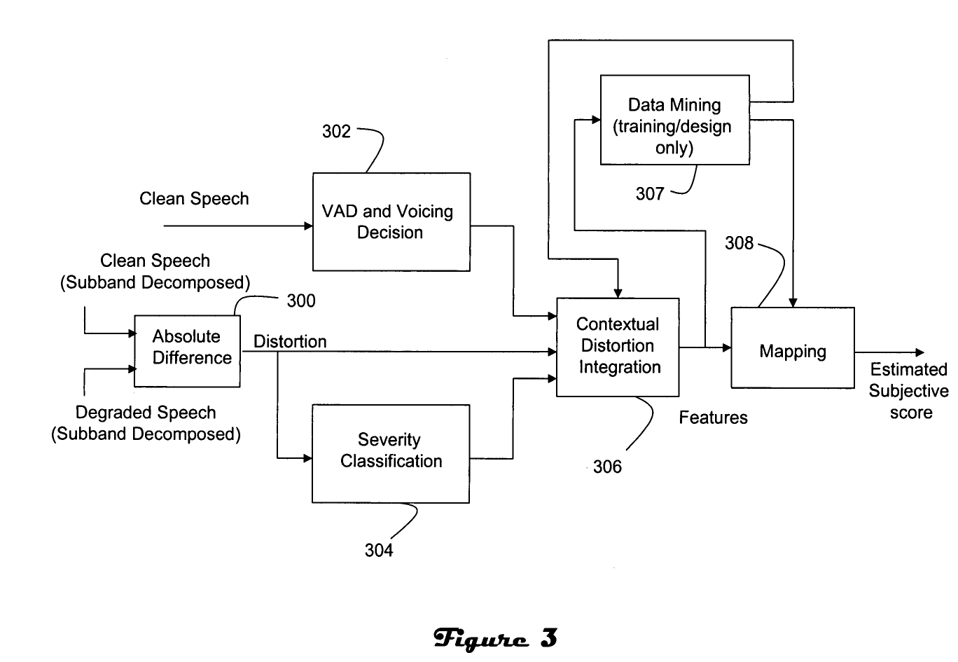

Referring now to FIGS. 1 and 3, the first step in designing the cognitive mapping (102) is to extract a large number of features from the output signal of the auditory processing steps (100a, 100b). Once cognitive mapping is designed, it operates using only a small subset of the totality of features examined in the design process. The clean and degraded speech signals, decomposed into subjective loudness distributions over Bark frequency and time, are subtracted to produce a difference as shown in step (300). The difference over the entire speech file corresponds to a distortion surface over time-frequency. Cognitive mapping operates by integrating the distortion surface by segmentation, classification, and integration.

The frequency decomposed 7-subband distortions for each frame are then classified by a two-stage process. The first stage is time domain segmentation based on voice activity detection (“VAD”) and voicing decisions, as shown in step (302). Each speech frame is classified into one of three categories: inactive, voiced, or unvoiced. Consequently, the distortion in each time-frequency bin gets classified into one of twenty one (3*7=21) classes.

Distortions from the first stage are further classified, as indicated in step (304), by the severity of the frame-distortion into three different categories: small, medium, or large. Hence, after two stages of classification the distortions are assigned to one of sixty three (3*21=63) classes. The distortions in each of the 63 classes are averaged using L₂ norm. The integrated distortion from each class, produced in step (306), is referred to as a “feature.” Other types of features include rank-ordered distortions, weighted mean distortion, and probability of each type of speech frame. At least 209 different features have been identified as available for data mining, examples of which will be discussed in greater detail below.

Various statistical analysis techniques may be employed, either alone or in combination, to perform data mining or machine learning for cognitive mapping in step (307). The data mining step is active only during a training or design phase. Design and operation differ in that many features are generated during design for mining, but during operation only the features selected through mining need to be computed. In the illustrated embodiment a Multivariate Adaptive Regression Spline (“MARS”) technique is employed in the statistical data mining step (307). Other data mining or machine learning schemes such as Classification and Regression Trees (“CART”) could also be employed. MARS builds large regression models over two processing steps. A first, forward, step recursively partitions the data domain into smaller regions. In each recursion step, a feature variable is selected for partitioning perpendicular to the variable. Two spline “basis functions,” one for each of the two newly created partition regions, are added to the model under construction. The feature variable to choose and the point of partition can be found via brute-force search. An overly large model may be built initially. In a second, backward, step basis functions that contribute least to performance are deleted.

From the large number of features extracted from the distortion surface MARS is employed to find a small subset of features to form the speech quality estimator. The subset of feature variables, together with the particular manner of combining them, are jointly optimized to produce a statistically consistent estimate (data model) of subjective MOS. It should be noted that once the data mining techniques have been employed to produce the data model, that data model can be utilized to score different speech signals. Further, the model can be updated through further learning.

The final step is mapping (308). Once the selected subset of feature variables, together with the particular manner of combining them, are jointly optimized to produce a statistically consistent estimate (data model) of subjective opinion scores such as MOS, the data model can be employed to produce an estimate of MOS for a speech signal that was not employed for generating the data model. That is done in the mapping step.

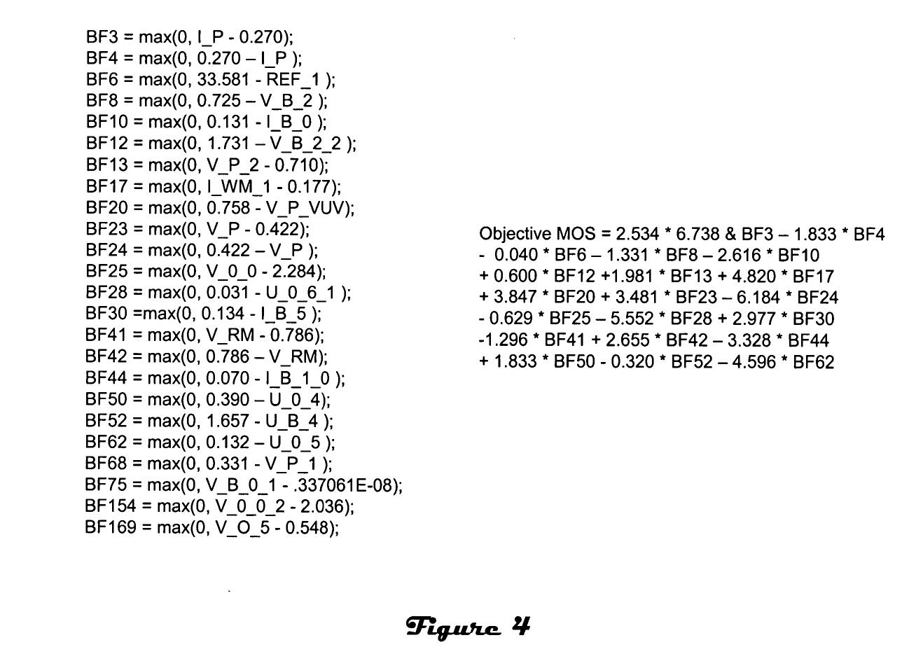

Referring now to FIG. 4, the illustrated features are employed in accordance with the illustrated data model to produce the objective MOS score. In the feature variables, the first letter (denoted by T in a variable name) gives the frame type: T=I for Inactive, T=V for Voiced, and T=U for Unvoiced. The subband index is denoted by b, with bε{0, . . . , 6} indexing from the lowest to the highest frequency band if the index is natural, or from the highest to the lowest distortion if the index is rank-ordered. The frame distortion severity class is denoted by d, with dε{0,1,2} indexing from lowest to highest severity. With the above notations, the feature variables are:
T_P_d: fraction of T frames in severity class d frames;
T_P: fraction of T frames in the speech file;
T_P_VUV: ratio of the number of T frames to the total number of active (V and U) speech frames;
T_B_b: distortion for subband b of T frames, without distortion severity classification, e.g., I_B_{—}1 represents sub-band 1 distortion for inactive frames;
T-B_b_d: distortion for severity class d of subband b of T frames, e.g., V_B_{—}3_{—}2 represents distortion for subband 3, severity class 2, of voiced frames;
T_O_b: distortion for ordered subband b of T frames, without severity classification, e.g., U_O_{—}3 represents ordered-subband 3 distortion for unvoiced frames, without distortion severity classification;
T_O_b_d: distortion for distortion class d of ordered sub-band b of T frames, e.g., U_O_{—}6_{—}1 represents distortion for severity class 1 of ordered-subband 6 of unvoiced frames;
T_WM_d: weighted mean distortion for severity class d of T frames;
T_WM: weighted mean distortion for T frames;
T_RM_d: root-mean distortion for severity class d of T frames;
T_RM: root-mean distortion for T frames;
REF_{—}0: the loudness of the lower 3.5 subbands of the reference signal; and
REF_{—}1: the loudness of the upper 3.5 subbands of the reference signal.

While the invention is described through the above exemplary embodiments, it will be understood by those of ordinary skill in the art that modification to and variation of the illustrated embodiments may be made without departing from the inventive concepts herein disclosed. Moreover, while the preferred embodiments are described in connection with various illustrative structures, one skilled in the art will recognize that the system may be embodied using a variety of specific structures. Accordingly, the invention should not be viewed as limited except by the scope and spirit of the appended claims.

What is claimed is:

1. A method for using a data model for measuring speech quality from a clean speech signal and a degraded speech signal, comprising the steps of:
performing auditory processing of the clean speech signal, thereby producing a subband decomposition of the clean speech signal;
performing auditory processing of the degraded speech signal, thereby producing a subband decomposition of the degraded speech signal; and
performing cognitive mapping based on the clean speech signal, the subband decomposition of the clean speech signal, and the subband decomposition of the degraded speech signal.

2. The method of claim 1 including the further step of aggregating cognitively similar distortions through segmentation and classification.

3. The method of claim 2 including the further step of calculating the absolute difference between the subband decomposition of the clean speech signal and the subband decomposition of the degraded speech signal.

4. The method of claim 3 including the further step of performing time domain segmentation based on voice activity detection.

5. The method of claim 4 including the further step of classifying frame distortion severity.

6. The method of claim 1 including the further step of generating the data model for measuring speech quality from the clean speech signal and the degraded speech signal.

7. The method of claim 6 including the further step of employing at least one statistical data mining technique on the features to identify a subset of more significant features.

8. The method of claim 1 including the further step calculating a weighted combination of the identified subset of features operable as a data model for estimating subjective listening scores.

9. The method of claim 6 wherein the statistical data mining technique includes one or more of Multivariate Adaptive Regression Splines (“MARS”) and Classification and Regression Trees (“CART”).

10. The method of claim 8 including the further step of employing the data model to produce an estimate of subjective listening score for a speech signal that was not employed for generating the data model.

11. A computer program operable to use a data model for measuring speech quality from a clean speech signal and a degraded speech signal, comprising:
logic operable to perform auditory processing of the clean speech signal, thereby producing a subband decomposition of the clean speech signal;
logic operable to perform auditory processing of the degraded speech signal, thereby producing a subband decomposition of the degraded speech signal; and
logic operable to perform cognitive mapping based on the clean speech signal, the subband decomposition of the clean speech signal, and the subband decomposition of the degraded speech signal.

12. The computer program of claim 11 further including logic operable to aggregate cognitively similar distortions through segmentation and classification.

13. The computer program of claim 12 further including logic operable to calculate the absolute difference between the subband decomposition of the clean speech signal and the subband decomposition of the degraded speech signal.

14. The computer program of claim 13 further including logic operable to perform time domain segmentation based on voice activity detection.

15. The computer program of claim 14 further including logic operable to classify frame distortion severity.

16. The computer program of claim 15 further including logic operable to generate the data model for measuring speech quality from the clean speech signal and the degraded speech signal.

17. The computer program of claim 16 further including logic operable to employ at least one statistical data mining technique on the features to identify a subset of more significant features.

18. The computer program of claim 17 further including logic operable to calculate a weighted combination of the identified subset of features operable as a data model for estimating subjective listening scores.

19. The computer program of claim 17 wherein the statistical data mining technique includes one or more of Multivariate Adaptive Regression Splines (“MARS”) and Classification and Regression Trees (“CART”).

20. The computer program of claim 18 further including logic operable to employ the data model to produce an estimate of subjective listening score for a speech signal that was not employed for generating the data model.
